(19) United States
(12) Patent Application Publication
(10) Pub. No.: US 2015/0049011 A1
(43) Pub. Date: Feb. 19, 2015

(54) METHOD AND APPARATUS FOR ENHANCING THREE-DIMENSIONAL IMAGE PROCESSING

(71) Applicant: BLACKBERRY LIMITED, Waterloo (CA)

(72) Inventors: Peter MANKOWSKI, Waterloo (CA); Jacek S. IDZIK, Kenilworth (CA); Cornel MERCEA, Waterloo (CA)

(73) Assignee: BLACKBERRY LIMITED, Waterloo (CA)

(21) Appl. No.: 13/967,743

(22) Filed: Aug. 15, 2013

(51) Int. Cl. G06F 3/01

(52) U.S. Cl. CPC G06F 3/01
USPC 345/156

(57) ABSTRACT

A system and method of controlling displayed three-dimensional visual content is disclosed. A signal is received from a user operated adjustment device, the signal being generated by a physical movement of the adjustment device by the user, wherein the signal corresponds to a desired adjustment of the displayed three-dimensional content. A value of an image-generation parameter of the three-dimensional visual content is adjusted corresponding to the signal received from the adjustment device. A physical parameter of a display device that displays the three-dimensional visual content is changed based on the adjusted value of the image-generation parameter in order to implement the desired adjustment of the displayed three-dimensional visual content.

### BACKGROUND

Existing three-dimensional displays are designed to provide a three-dimensional image that is best viewed within a selected “optimal” viewing region. Due to the nature of three-dimensional images, viewing the three-dimensional image from outside of the optimal viewing region may cause physical strain to the viewer, such as headaches for example. Therefore, the viewer is often required to move his or her head into a selected position and to maintain the head position throughout the viewing, which can become uncomfortable. Current three-dimensional displays lack any awareness of a viewer's spatial relation to the display, such as the distance between viewer and display and a horizontal and/or vertical position of the viewer with respect to the display and therefore can not accommodate the viewer with respect to having a more pleasing experience.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows an illustrative embodiment of an interactive three-dimensional display system of the present invention;

FIG. 2 shows a top view of an illustrative display of the interactive three-dimensional display system;

FIG. 3 shows an illustrative embodiment of an adjustment device used with the interactive three-dimensional display system of FIG. 1;

FIG. 4 shows a flowchart illustrating a method of adjusting a three-dimensional visual content viewing experience using the method disclosed herein;

FIG. 5 is a view of a mobile electronic device that can display three dimensional images; and

FIG. 6 is a schematic view of the mobile electronic device of FIG. 5.

### DETAILED DESCRIPTION

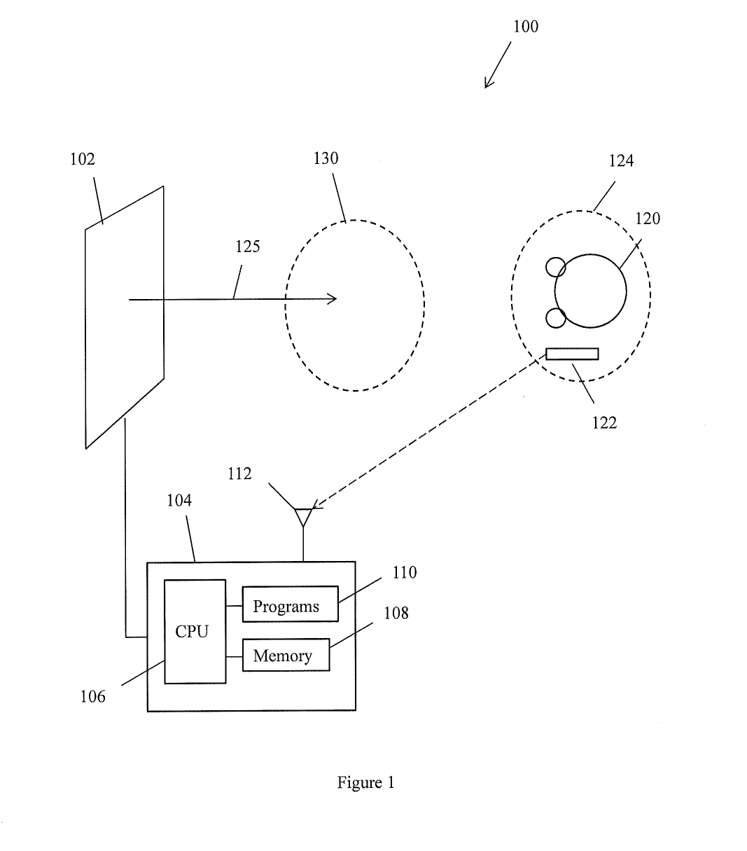

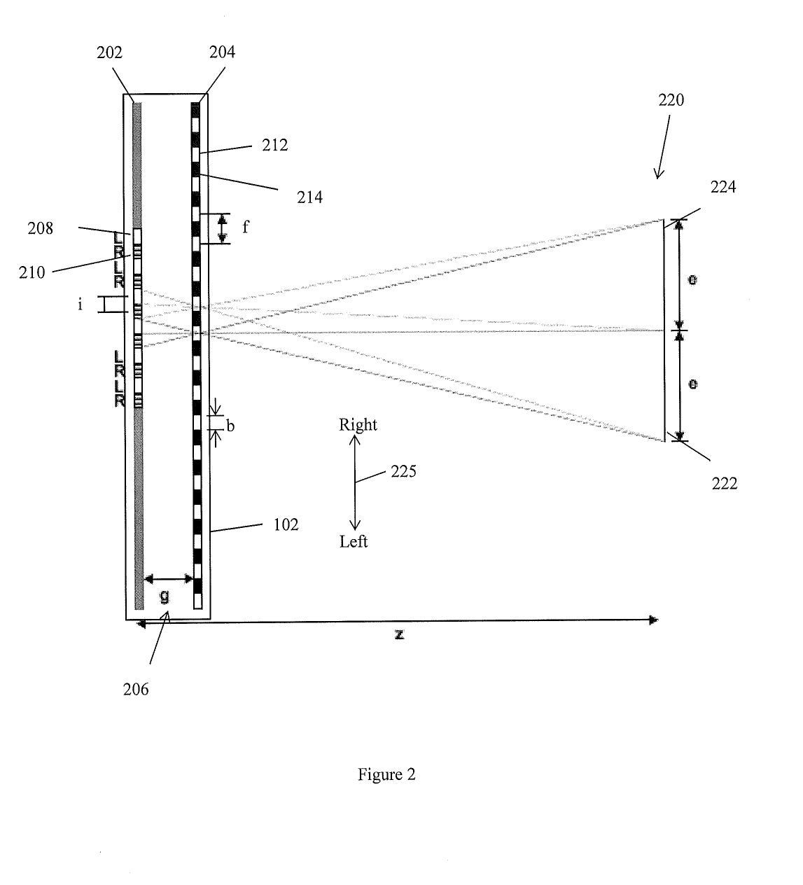

FIG. 1 shows an illustrative embodiment of an interactive three-dimensional display system 100 of the present invention. The interactive three-dimensional display system 100 includes a display device 102, also referred to herein as a “display,” for displaying three-dimensional visual content (“3D content”), which may be a three-dimensional image or a three-dimensional movie content (e.g., video that is still or in motion). The display 102 may be a stereoscopic display that creates an illusion of depth in an image by means of binocular vision. The display 102 may also be an autostereoscopic display that displays stereoscopic images without the use of special headgear or glasses on the part of the viewer. The display 102 may be a three-dimensional television screen or a three-dimensional display of a mobile device, in various embodiments. The display 102 has one or more physical parameters that affect the presentation of the 3D content, as discussed below with respect to FIG. 2. The display 102 may generate the 3D content with the display 102 set at selected values of these physical parameters. The 3D content may be best viewed within an “optimal” viewing location 130, which location is determined by the various settings or values of the physical parameters of the display 102. Changing these physical parameters of the display 102 may affect a location of the “optimal” viewing location 130.

FIG. 2 shows a top view of an illustrative display 102 of the interactive three-dimensional display system 100. The display 102 includes a display screen 202 and a parallax barrier 204 in front of and parallel to the display screen 202. The parallax barrier 204 is offset from the display screen 202 by a gap 206 having a gap width g. A viewer 220 is located at a viewing location that is at a distance z from the display screen 202. The viewer 220 is represented by a set of viewing windows that correspond to a left eye 222 and right eye 224 of the viewer 220. The intraocular separation of the left eye 222 and the right eye 224 is invariant. The display screen 202 includes an alternating pattern of left-eye pixels 208 intended to be viewed by the left eye 222 of the viewer 220 and right-eye pixels 210 intended to be viewed by the right eye 224 of the viewer 220. The pixels 208 and 210 are separated by a selected distance referred to as a pixel pitch i. The parallax barrier 204 includes an alternating pattern of apertures (“slits”) 212 and barriers 214. The slits 212 may have a slit width b and the barriers 214 may be separated by a distance referred to as a barrier pitch f. The settings or values of the various physical parameters of the display 102, i.e., the pixel pitch i, the gap g, the barrier pitch b, the slit width f, etc. determine at which distance z the image of the left-eye pixels 208 and the right-eye pixels 210 come into their respective focuses and therefore an ideal viewing location for the 3D content being generated at the display 102.

Many of these physical parameters of the display 102 may be dynamic and may be altered or changed upon receipt of a set of image-generation parameters at the display 102. In one embodiment, the physical parameter may be changed while the 3D content such as a 3D movie is being shown. Changing the physical parameters of the display 102 affects, among other things, the viewing distance z. For example, the size of the gap g between the display screen 202 and parallax barrier 204 affects the viewing distance z of the viewer 220. For a given intraocular distance of the left eye 222 and right eye 224 of the viewer 220, increasing the size of gap 206 may increase the viewing distance z from the display screen 202. Similarly, decreasing the size of gap 206 may decrease the viewing distance z from the display screen 202. As another example, moving the parallax barrier 204 along a left-right direction 225 moves the viewing location to the left and/or right of the display 102. In various embodiments, the physical parameter may be changed to adjust horizontal referencing

In another embodiment, the display may provide 3D content by alternately displaying the images of the right-eye pixels and the images of the left-eye pixels. Thus, the timing sequence may be a physical parameter that may be changed using the methods herein. In another embodiment the display may provide 3D content by the use of lenticular lenses. Thus, a pitch of the lenticular lenses and/or angle of incidence of image rays on the lenticular lenses may be a physical parameter that may be changed using the methods herein.

In one embodiment, the display 102 sets a physical parameter such as gap size g to a value that corresponds to a value of an image-generation parameter received at the display 102. The values of these image-generation parameters may be stored as metadata to the 3D content. In one embodiment, the values of the image-generation parameters may be selected via a viewer having access to an remote adjustment device 122, as discussed below with respect to FIG. 1.

Returning to FIG. 1, the display 102 may be coupled to a control unit 104 that provides the 3D content and various image-generation parameter metadata to the display 102. The control unit 104 may include a processor 106, a memory location 108 and one or more programs 110 for performing the methods disclosed herein. The 3D content may be stored at the memory location 108 and the processor 106 may access the memory location 108 to send the 3D content to the display 102. The processor 106 may also access various image-generation parameters from the memory location 108 and use the image-generation parameters to select a setting of a corresponding physical parameter of the display 102 to match the value of the image-generation parameter. The control unit 104 may further include a receiver 112 that may receive a signal from a remote adjustment device 122. The processor 106 may dynamically adjust the value of an image-generation parameter of the 3D content corresponding to the received signal. The processor 106 may then change the setting of the selected physical parameter to correspond to the selected value of the image-generation parameter. Thus, a viewer 120 may use the adjustment device 122 to implement a desired adjustment of the displayed 3D content.

The adjustment device 122 may be used at a location 124 that is remote from the display 102 to adjust the 3D content. In one embodiment, the location 124 substantially corresponds to a viewing location of the viewer 120. In an exemplary embodiment, the adjustment device 122 is a motion-sensitive device that is capable of measuring its own motion of physical movement within a three-dimensional space. In an exemplary embodiment, the motion of the adjustment device 122 is sensed or measured at the adjustment device 122 and the measured motion is converted to a signal that is transmitted from the remote adjustment device 122 to the control unit 104 via the receiver 112. The control unit 104 may determine a type of motion (e.g., rotation in an up-down direction, rotation in a left-right direction) performed at the adjustment device 122 and a degree or amount (e.g., 5 degrees, 10 degrees, etc.) of the determined type of motion. The determined type of motion may be used to select an image-generation parameter. The degree or amount of the motion may be used to alter a value of the selected image-generation parameter. As an illustrative example, a left-right rotation of the adjustment device 122 may select an image-generation parameter for gap size and a 20 degree rotation to the right may increase gap size by 2 millimeters while a 20 degree rotation to the left may decrease gap seize by 2 millimeters. In various embodiments, a pre-determined relation may be set up so that an amount by which the value of the image-generation parameter is altered corresponds to the amount of motion measured at the adjustment device 122. Thus the viewer 120 may use the adjustment device 122 to alter the physical parameters of the display 102 so that the “optimal” viewing location 130 coincidences with his/her viewing location 124. Also, the adjustment device may be used to adjust a parameter of the 3D content, such as focus, depth of field, etc., to a desired setting. When the viewer 120 is satisfied with a setting the viewer may end the adjustment process and the latest value of the image-generation parameter is stored as a selected value. In another embodiment, the display 102 may create 3D content by alternating in time the showing of left-eye pixels 208 and right-eye pixels 210. Thus, an image-generation parameter may be used to control a timing sequence of the left-eye pixels and the right-eye pixels 210.

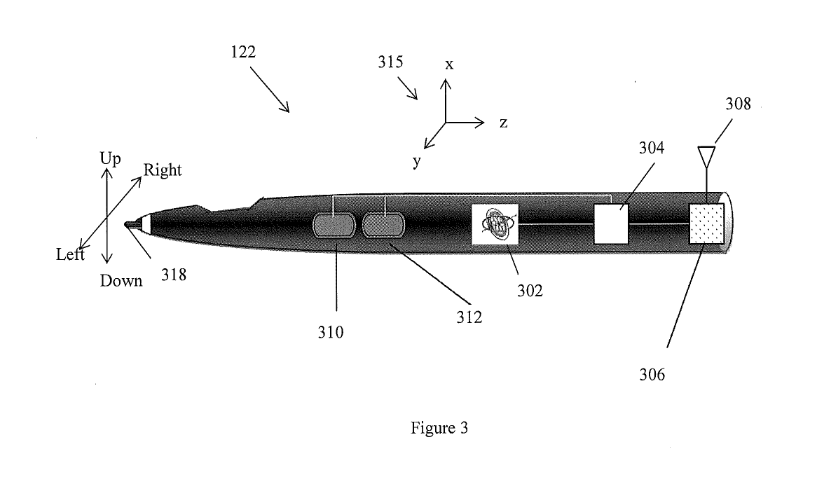

FIG. 3 shows an illustrative embodiment of an adjustment device 122 used with the interactive three-dimensional display system 100 of FIG. 1. The adjustment device 122 is shown to be in the form of a pen or stylus but may take any suitable shape. Nonetheless, the illustrated shape of the adjustment device 122 shown in FIG. 3 enables the viewer to intuitively “point” or orient the adjustment device 122 in a selected direction, thereby facilitating the viewer's ability to recognize how much motion or orientation in space has occurred at the adjustment device 122. The adjustment device 122 includes one or more motion sensors 302 which may include one or more accelerometers and/or one or more gyroscopes, a processing unit 304 and a communication module 306. The one or more accelerometers may include an orthogonal set of accelerometers for determining a motion in x- y- and z-directions as indicated by the coordinate system 315. The one or more gyroscopes may be used to determine a change in orientation of the adjustment device 122. The motion sensors 302 may generate a voltage or current in response to motion or re-orientation of the adjustment device 122. The generated voltage or current may be sent to the processing unit 304 which determines an amount or type of motion from the received voltage or current. The processing unit 304 may then communicate the determined measurement of motion to the communication module 306 of the adjustment device 122. In one embodiment, the communication module 306 includes a transmitter 308 that transmits a signal indicative of the determined motion to the control unit 104. In various embodiments, the signal may be transmitted from the communication module 306 to the control unit 104 via Bluetooth wireless communication link or other suitable communication link.

In an illustrative embodiment, the processor 106 of control unit 104 alters a value of a selected image-generation parameter to correspond to a selected motion of the adjustment device 122. For example, a rotation of the adjustment device 122 along a left-right direction (e.g., rotation around the x-axis) may be used to adjust vertical displacement coordinates of the 3D content. Rotating the adjustment device 122 so that its tip 318 is sent to the right may increase the quality of the 3D content as viewed from a viewing location above a central axis (125, FIG. 1) of the display 102. Rotating the adjustment device 122 so that its tip 318 is sent to the left may similarly adjust a physical parameter of the display 102 to increase a quality of the 3D content as viewed from a viewing location below the central axis (125, FIG. 1) of the display 102. As another example, rotating the adjustment device in an up-down direction (e.g., rotation around the y-axis) may adjust a physical parameter of the display 102 that affects a viewing distance of the 3D content. For example, rotating the adjustment device 122 so that tip 318 moves upward may move an optimal viewing location away from the display 102 and rotating the adjustment device 122 so that tip 318 moves downward may move the optimal viewing location toward the display 102.

While the processing unit 304 may measure a change in the relative orientation and/or position of the adjustment device 122, the processing unit 304 is generally unaware of its relative position or orientation of the adjustment device 122 with respect to the display 102 of FIG. 1. Instead, the viewer moves the adjustment device 122 in a selected motion to have a prescribed effect on the generation of the physical parameter involved with generating the 3D content.

The adjustment device 122 may also include various selection devices (310, 312) such as buttons, switches, toggles, etc., that may be selected in order to activate and/or deactivate the adjustment device 122 with respect to measuring its own physical movement. The selection device 310 and 312 may be coupled to the processing unit 304. The state of the selection device may be used either an ON/OFF switch or to select an image-generation parameter. In one embodiment, the user holds the adjustment device 122 in a selected position, activates a selected selection device (i.e., top button 310) and moves the adjustment device in a selected motion. Pushing the top button 310 may indicate to the processing unit 304 to begin measuring the physical movement of the adjustment device 122. Releasing the button 310 may indicate to the processing unit 304 to stop measuring the physical movement of the adjustment device 122.

In another embodiment, the measured motion of the adjustment device may be applied to different image-generation parameters depending on which selection device is activated. Also, a physical motion in combination with activating a selection device therefor may be used to adjust one image-generation parameter, while a physical motion on without activating the selection device may be used to adjust another image-generation parameter. For example, by selecting the top button 310, a left-right motion of the adjustment device may be used to move an object into and out of a background. In this embodiment, this button may consider a selected 3D depth slider button. In the same example, by selecting bottom button 312, a left-right motion of the adjustment device may be used to select a 3D focus point of the 3D content.

In one aspect of the present invention, the image-generation parameters are dynamic interrupts that may be altered during a viewing of the 3D content rather than a static integer that is not changed.

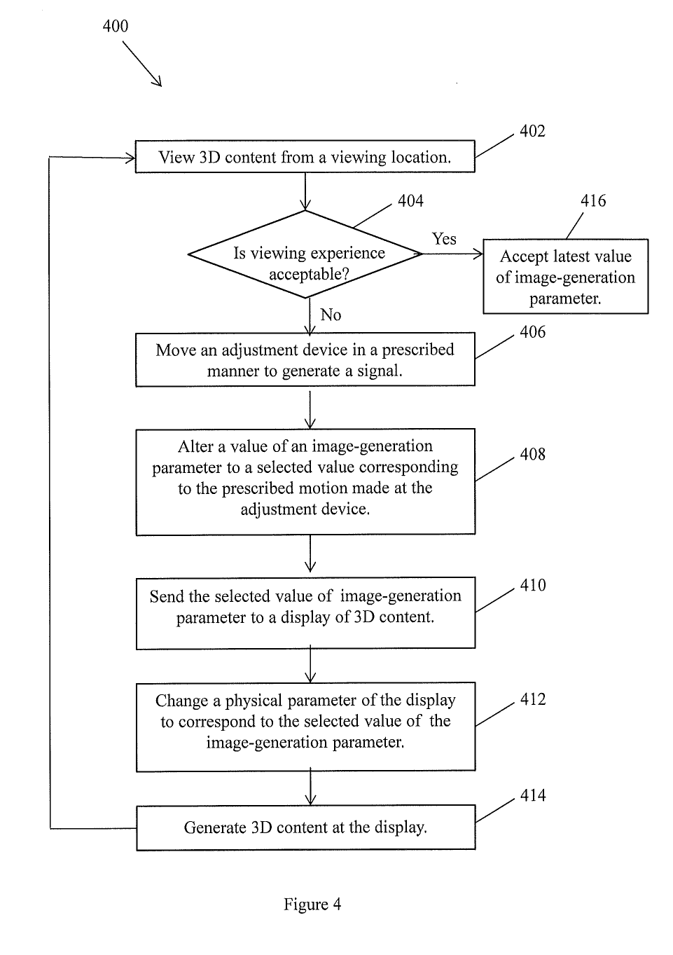

FIG. 4 shows a flowchart 400 illustrating a method of adjusting a 3D content viewing experience using the method disclosed herein. In block 402, the 3D content is viewed by a viewer at a viewing location. In block 404, the viewer decides whether the 3D content as viewed at the viewing location is acceptable. If the 3D content is not acceptable at the viewing location, the method moves to block 406. In block 406, the viewer moves an adjustment device in a prescribed manner to generate a signal, as disclosed herein. In block 408, the signal is used to alter a value of an image-generation parameter to a selected value. In block 410, the selected value of the image-generation parameter is sent to a display that is generating the 3D content. In block 412, a physical parameter of the display is altered to a value that corresponds to the selected value of the image-generation parameter. In block 414, 3D content is generated at the display under the altered physical parameter of the display. The method then returns to block 402 where the viewer once again views the 3D content at the viewing location. Returning to block 404, if the 3D content is considered to be acceptable to the viewer, the method proceeds to block 416, at which point the viewer accepts the latest value of the image-generation parameter and the method ends.

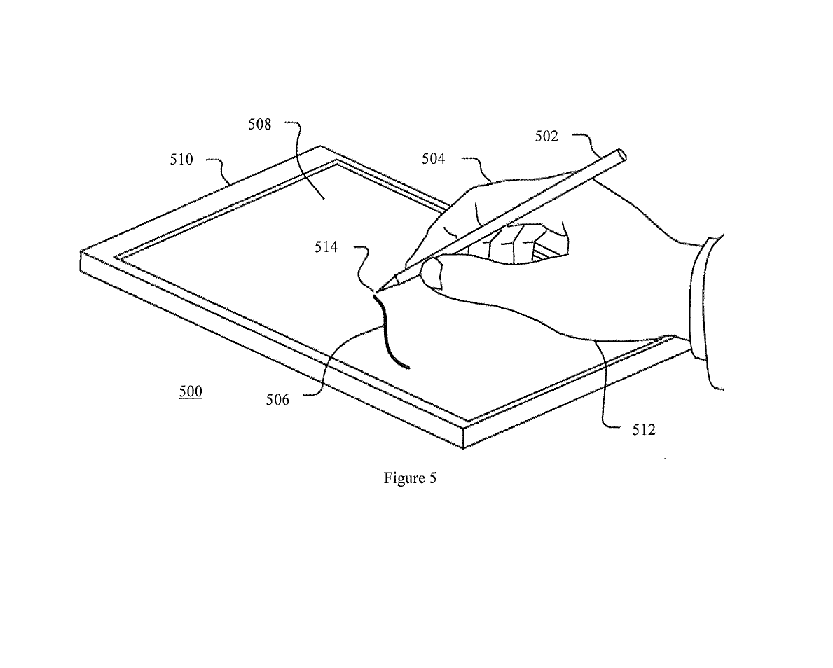

FIG. 5 is a diagram of an illustrative electronic system 500, in accordance with some embodiments of the disclosure. In FIG. 5, a stylus 502 or other user device is manipulated by a user 504 to interact with touchscreen 508 of an electronic device 510 to draw a line or other image 506 on the touch screen 508. In operation, the touch screen 508 of the electronic device 510 senses one or more touch positions at which a pointing device, such as a stylus 502, touches, or almost touches, the touch screen 508. The touch screen 508 may be a capacitive or resistive touch screen, for example. The touch screen 508 may further include a screen capable of displaying a three-dimensional or stereoscopic visual content. The electronic device 510 may be, for example, a laptop computer, tablet computer (tablet), mobile phone, personal digital assistant (PDA), or other portable or non-portable electronic device. The stylus 502 also has the ability to control the 3D content being displayed at the touch screen 508 using the methods disclosed herein.

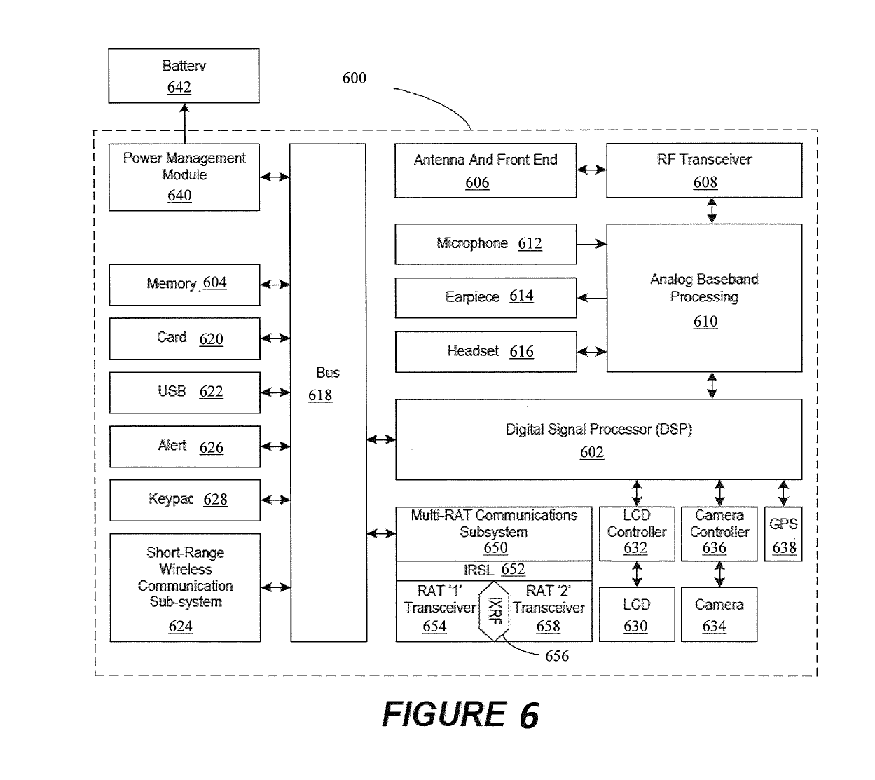

FIG. 6 depicts a block diagram of an exemplary electronic device 600, e.g., electronic device 500 of FIG. 5, or another computing device in accordance with an embodiment of the disclosure. While various components of a device 600 are depicted, various embodiments of the device 600 may include a subset of the listed components or additional components not listed. As shown in FIG. 6, the device 600 includes a processor 602 (to process the 3D images as described herein) and a memory 604 (to store instructions to be executed to create the 3D images described herein). As shown, the device 600 may further include an antenna and front end unit 606, a radio frequency (RF) transceiver 608, an analog baseband processing unit 610, a microphone 612, an earpiece speaker 614, a headset port 616, a bus 618, such as a system bus or an input/output (I/O) interface bus, a removable memory card 620, a universal serial bus (USB) port 622, a short range wireless communication sub-system 624, an alert 626, a keypad 628, a display 630, which may include a touch sensitive surface and which may be a display capable of displaying 3D content, a display controller 632, a charge-coupled device (CCD) camera 634, a camera controller 636, and a global positioning system (GPS) sensor 638, and a power management module 640 operably coupled to a power storage unit, such as a battery 642. In various embodiments, the device 600 may include another kind of display that does not provide a touch sensitive screen. In one embodiment, the DSP 602 communicates directly with the memory 604 without passing through the input/output interface (“Bus”) 618.

In various embodiments, the DSP 602 or some other form of controller or central processing unit (CPU) operates to control the various components of the device 600 in accordance with embedded software or firmware stored in memory 604 or stored in memory contained within the DSP 602 itself. In addition to the embedded software or firmware, the DSP 602 may execute other applications stored in the memory 604 or made available via information media such as portable data storage media like the removable memory card 620 or via wired or wireless network communications. The application software may comprise a compiled set of machine-readable instructions that configure the DSP 602 to provide the desired functionality, or the application software may be high-level software instructions to be processed by an interpreter or compiler to indirectly configure the DSP 602.

The antenna and front end unit 606 may be provided to convert between wireless signals and electrical signals, enabling the device 600 to send and receive information from a cellular network or some other available wireless communications network or from a peer device 600. In an embodiment, the antenna and front end unit 606 may include multiple antennas to support receipt of signals from remote adjustment device 122. Likewise, the antenna and front-end unit 606 may include antenna tuning or impedance matching components, RF power amplifiers, or low noise amplifiers.

Note that in this diagram the radio access technology (RAT) RAT1 and RAT2 transceivers 654, 658, the IXRF 656, the IRSL 652 and Multi-RAT subsystem 650 are operably coupled to the RF transceiver 608 and analog baseband processing unit 610 and then also coupled to the antenna and front end 606 via the RF transceiver 608. As there may be multiple RAT transceivers, there will typically be multiple antennas or front ends 606 or RF transceivers 608, one for each RAT or band of operation.

The analog baseband processing unit 610 may provide various analog processing of inputs and outputs for the RF transceivers 608 and the speech interfaces (612, 614, 616). For example, the analog baseband processing unit 610 receives inputs from the microphone 612 and the headset 316 and provides outputs to the earpiece 614 and the headset 616. To that end, the analog baseband processing unit 610 may have ports for connecting to the built-in microphone 612 and the earpiece speaker 614 that enable the device 600 to be used as a cell phone. The analog baseband processing unit 610 may further include a port for connecting to a headset or other hands-free microphone and speaker configuration. The analog baseband processing unit 610 may provide digital-to-analog conversion in one signal direction and analog-to-digital conversion in the opposing signal direction. In various embodiments, at least some of the functionality of the analog baseband processing unit 610 may be provided by digital processing components, for example by the DSP 602 or by other central processing units.

The DSP 602 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 602 may perform modulation, coding, interleaving, and spreading, and for a receiver function the DSP 602 may perform despreading, deinterleaving, decoding, and demodulation. In another embodiment, for example in an orthogonal frequency division multiplex access (OFDMA) technology application, for the transmitter function the DSP 602 may perform modulation, coding, interleaving, inverse fast Fourier transforming, and cyclic prefix appending, and for a receiver function the DSP 602 may perform cyclic prefix removal, fast Fourier transforming, deinterleaving, decoding, and demodulation. In other wireless technology applications, yet other signal processing functions and combinations of signal processing functions may be performed by the DSP 602.

The DSP 602 may communicate with a wireless network via the analog baseband processing unit 610 or communicate with the remote adjustment device 122. In some embodiments, the communication may provide Internet connectivity, enabling a user to gain access to content on the Internet and to send and receive e-mail or text messages. The input/output interface 618 interconnects the DSP 602 and various memories and interfaces. The memory 604 and the removable memory card 620 may provide software and data to configure the operation of the DSP 602. Among the interfaces may be the USB interface 622 and the short range wireless communication sub-system 624. The USB interface 622 may be used to charge the device 600 and may also enable the device 600 to function as a peripheral device to exchange information with a personal computer or other computer system. The short range wireless communication sub-system 624 may include an infrared port, a Bluetooth interface, an IEEE 802.11 compliant wireless interface, or any other short range wireless communication sub-system, which may enable the device 600 to communicate wirelessly with other nearby client nodes and access nodes. The short-range wireless communication Sub-system 624 may also include suitable RF Transceiver, Antenna and Front End subsystems.

The keypad 628 couples to the DSP 602 via the I/O interface (“Bus”) 618 to provide one mechanism for the user to make selections, enter information, and otherwise provide input to the device 600. The keyboard 628 may be a full or reduced alphanumeric keyboard such as QWERTY, DVORAK, AZERTY and sequential types, or a traditional numeric keypad with alphabet letters associated with a telephone keypad. The input keys may likewise include a track wheel, track pad, an exit or escape key, a trackball, and other navigational or functional keys, which may be inwardly depressed to provide further input function. Another input mechanism may be the LCD 630, which may include touch screen capability and also display text and/or graphics to the user. The LCD controller 632 couples the DSP 602 to the LCD 630.

The CCD camera 634, if equipped, enables the device 600 to make digital pictures. The DSP 602 communicates with the CCD camera 634 via the camera controller 636. In another embodiment, a camera operating according to a technology other than Charge Coupled Device cameras may be employed. The GPS sensor 638 is coupled to the DSP 602 to decode global positioning system signals or other navigational signals, thereby enabling the device 600 to determine its position. The GPS sensor 638 may be coupled to an antenna and front end (not shown) suitable for its band of operation. Various other peripherals may also be included to provide additional functions, such as radio and television reception.

In various embodiments, the device 600 comprises a first Radio Access Technology (RAT) transceiver 654 and a second RAT transceiver 658. As shown in FIG. 6, the RAT transceivers ‘1’ 654 and ‘2’ 658 are in turn coupled to a multi-RAT communications subsystem 650 by an Inter-RAT Supervisory Layer Module 652. In turn, the multi-RAT communications subsystem 650 is operably coupled to the Bus 618. Optionally, the respective radio protocol layers of the first Radio Access Technology (RAT) transceiver 654 and the second RAT transceiver 658 are operably coupled to one another through an Inter-RAT eXchange Function (IRXF) Module 656.

In various embodiments, a network node acting as a server comprises a first communication link corresponding to data to/from the first RAT and a second communication link corresponding to data to/from the second RAT.

As described herein, a viewer may affect his or her viewing of 3D content. The viewer may view the 3D content generated by a display device having a first setting of an image-generation parameter, perform a physical movement of the adjustment device in space to change the setting of the physical parameter from the first setting to a second setting, and view the 3D content as it is generated by the display device using the second setting.

Therefore, in one aspect of the present invention, a method of controlling displayed three-dimensional visual content includes: receiving a signal from a user operated adjustment device, the signal being generated by a physical movement of the adjustment device by the user, wherein the signal corresponds to a desired adjustment of the displayed three-dimensional content; adjusting a value of an image-generation parameter of the three-dimensional visual content corresponding to the signal received from the adjustment device; and changing a physical parameter of a display device that displays the three-dimensional visual content, based on the adjusted value of the image-generation parameter, so as to implement the desired adjustment of the displayed three-dimensional visual content.

In another aspect of the present invention, a system for displaying three-dimensional visual content includes: a three-dimensional display device; a control unit in communication with the display device; and a user-operated adjustment device configured to generate a signal by a physical movement of the adjustment device by the user, wherein the signal corresponds to a desired adjustment of displayed three-dimensional content by the three-dimensional display device; wherein the control unit is configured to: receive the signal from the adjustment device; adjust a value of an image-generation parameter of the three-dimensional visual content corresponding to the signal; and change a physical parameter of the display device, based on the adjusted value of the image-generation parameter, so as to implement the desired adjustment of the displayed three-dimensional content.

In yet another aspect of the present invention, a method of viewing three-dimensional visual content includes: generating the three-dimensional visual content at a display device using a first setting of a physical parameter of the display; moving an adjustment device in space to alter the physical parameter of the display from the first setting to a second setting; and viewing the three-dimensional visual content generated using the second setting of the physical parameter of the display.

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of controlling displayed three-dimensional visual content, the method comprising:
receiving a signal from a user operated adjustment device, the signal being generated by a physical movement of the adjustment device by the user, wherein the signal corresponds to a desired adjustment of the displayed three-dimensional content;
adjusting a value of an image-generation parameter of the three-dimensional visual content corresponding to the signal received from the adjustment device; and
changing a physical parameter of a display device that displays the three-dimensional visual content, based on the adjusted value of the image-generation parameter, so as to implement the desired adjustment of the displayed three-dimensional content.

2. The method of claim 1, further comprising displaying the three-dimensional visual content at the display using the changed physical parameter.

3. The method of claim 2, wherein the physical parameter is at least one of: a gap between a display screen and a parallax barrier of the display, a timing of left and right images of the three-dimensional visual content.

4. The method of claim 1, further comprising adjusting the value of the image-generation parameter to a selected value for viewing the three-dimensional visual content at a selected viewing location.

5. The method of claim 1, further comprising obtaining a measurement of the physical movement of the adjustment device using at least one motion sensor of the adjustment device.

6. The method of claim 1, wherein the physical movement of the adjustment device further comprises a change of an orientation in space of the adjustment device.

7. The method of claim 1, further comprising selecting the image-generation parameter from a plurality of image-generation parameters using one of: a selected physical movement of the adjustment device; and a selected physical movement of the adjustment device in combination with activating a selection device of the adjustment device.

8. The method of claim 1, wherein adjusting the value of the image-generation parameter performs at least one of: adjusting a viewing distance with respect to the display; adjusting a vertical location of the viewer with respect to the display; adjusting a horizontal displacement of the viewer with respect to the display; moving a selected object with respect to a background of the three-dimensional visual content; and selecting a dynamic focal point of the three-dimensional visual content.

9. The method of claim 1, wherein the display device that is one of a television screen; a mobile device; a smartphone; and a tablet.

10. A system for displaying three-dimensional visual content, comprising:
a three-dimensional display device;
a control unit in communication with the display device; and
a user-operated adjustment device configured to generate a signal by a physical movement of the adjustment device by the user, wherein the signal corresponds to a desired adjustment of displayed three-dimensional content by the three-dimensional display device;
wherein the control unit is configured to:
receive the signal from the adjustment device;
adjust a value of an image-generation parameter of the three-dimensional visual content corresponding to the signal; and
change a physical parameter of the display device, based on the adjusted value of the image-generation parameter, so as to implement the desired adjustment of the displayed three-dimensional content.

11. The system of claim 10, wherein the display device generates the three-dimensional visual content using the altered value of the physical parameter.

12. The system of claim 11, wherein the physical parameter is at least one of: a gap between a display screen and a parallax barrier of the display, a timing of left and right images of the three-dimensional visual content.

13. The system of claim 10, wherein the control unit adjusts the value of the image-generation parameter to a value selected by a viewer of the three-dimensional visual content.

14. The system of claim 10, further comprises at least one motion sensor configured to measure the physical movement of the adjustment device to generate the signal.

15. The system of claim 14, wherein that at least one motion sensor measures a change in an orientation of the adjustment device.

16. The system of claim 1, further comprising selecting the image-generation parameter from a plurality of image-generation parameters using one of: a selected physical movement of the adjustment device; and a selected physical movement of the adjustment device combined with activated a selection device of the adjustment device.

17. The system of claim 10, wherein the control unit is further configured to change the setting of the physical parameter of the display device to perform at least one of: adjusting a viewing distance with respect to the display; adjusting a vertical location of the viewer with respect to the display; adjusting a horizontal displacement of the viewer with respect to the display; moving a selected object with respect to a background of the three-dimensional visual content; and selecting a dynamic focal point of the three-dimensional visual content.

18. The system of claim 10, wherein the display device further comprises one of:
a television screen; a mobile device; a smartphone; and a tablet.

19. A method of viewing three-dimensional visual content, comprising:
generating the three-dimensional visual content at a display device using a first setting of a physical parameter of the display;
moving an adjustment device in space to alter the physical parameter of the display from the first setting to a second setting; and
viewing the three-dimensional visual content generated using the second setting of the physical parameter of the display.

20. The method of claim 19, further comprising generating the three-dimensional visual content at a display device that is one of a television screen; a mobile device; a smartphone; and a tablet.
